(19) United States
(12) Patent Application Publication
(10) Pub. No.: US 2026/0357735 A1
(43) Pub. Date: Nov. 12, 2026

(54) DIESEL EXHAUST FLUID TEST SYSTEM

(71) Applicant: Southwest Research Institute, San Antonio, TX (US)

(72) Inventors: Charles E. ROBERTS, JR., Helotes, TX (US); Scott T. EAKLE, San Antonio, TX (US); Arun BALAKRISHNAN, San Antonio, CA (US); Christopher A. SHARP, Hollywood Park, TX (US); Daniel W. STEWART, Helotes, TX (US)

(21) Appl. No.: 19/670,735

(22) Filed: May 7, 2026

Related U.S. Application Data
(60) Provisional application No. 63/803,134, filed on May 9, 2025.

(51) Int. Cl. F01N 3/20; B01D 53/94; F01N 3/30

(52) U.S. Cl. CPC F01N 3/2066; B01D 53/9418; B01D 53/9431; B01D 53/9495; F01N 3/208; F01N 3/306; F01N 2610/1426; F01N 2610/1453; F01N 2900/1404; F01N 2900/1804; F01N 2900/1806; F01N 2900/1812

(57) ABSTRACT

A diesel exhaust test system and method. The test system can be configured as relatively small scale and is particularly suitable to conveniently evaluate deposit performance of different diesel exhaust fluid solutions contemplated for use in various types of diesel engines.

### FIELD

The present disclosure is directed at a diesel exhaust fluid test system and method. The test system can be configured as relatively small scale and is particularly suitable to conveniently evaluate deposit performance of different diesel exhaust fluid solutions contemplated for use in various types of diesel engines.

### BACKGROUND

Aqueous Urea Solution (AUS), also known as Urea Water Solution (UWS) or Diesel Exhaust Fluid (DEF) was introduced into mass use for relatively heavy-duty lean-burn engines in the early 2000’s to enable use of Selective Catalytic Reduction (SCR) aftertreatment systems. DEF is primarily a solution that is comprised of urea and water, with varying proportions for industries such as heavy-duty on-road trucks, non-road vehicles, and marine, to name a few.

The DEF is injected into the exhaust gas stream of the engine, upstream of the SCR catalyst, where the water evaporates and the urea undergoes chemical reaction to primarily become ammonia which acts a reductant on the SCR catalyst, converting exhaust gas oxides of nitrogen (NOx) to nitrogen (N₂). At some engine operating conditions, such as relatively low-loads and cold-starts, characterized by relatively low-exhaust gas temperatures, the water evaporation rate within the injected DEF is reduced and the chemical conversion of urea to ammonia is slowed. Additionally, competing side-reactions of urea-to-biuret and other deposit-forming materials can occur. If these conditions persist, deposit formation within the engine exhaust and aftertreatment system can lead to decreased NOx removal efficiency of the SCR, overall fuel-consumption increase of the engine, and possible irreversible damage to the SCR and associated aftertreatment system components

In addition, additives, such as surfactants and organometallic catalysts, can be blended into a DEF solution to, e.g., improve evaporation rates and to enhance the desired urea to ammonia reaction chemistry. . See, e.g., U.S. Patent No. 10,267,196 entitled Treatment Of Reductant Urea Solution With Catalyst Precursors To Assist Selective Catalytic Reduction. While the use of such additives may reduce the reduction of deposit formation and buildup within the engine exhaust and in SCR and other aftertreatment systems, a need still remains to evaluate deposit build-up to ensure that the exhaust system and SCR operation remains optimized.

Accordingly, a need remains for a DEF test system that is relatively small-scale and is suitable to evaluate deposit formation of different DEF solutions. Such a test system would therefore allow for the ability to more conveniently establish any DEF certification or regulatory requirements along with improved characterization capabilities for commercial entities introducing newer types of DEF into the market.

### SUMMARY

A diesel exhaust fluid test system comprising an air pump connected to a continuous conduit to provide an airflow, a heating zone in the continuous conduit to increase the temperature of the airflow, a diesel exhaust fluid doser in communication with the continuous conduit to introduce diesel exhuast fluid in the form of droplets, a deposit zone in the continuous conduit including a removable target to collect solid deposits formed from the diesel exhaust fluid.

A method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid doser in communication with said continuous conduit to introduce diesel exhaust fluid in the form of droplets and a deposit zone in said continuous conduit including a removable target to collect solid deposits formed from the diesel exhaust fluid;
introducing into said diesel exhuast fluid test system a first diesel exhaust fluid (DEF₁) and collecting solid deposits formed from said first diesel exhaust fluid;
introducing into said diesel exhaust fluid test system a second diesel exhaust fluid (DEF₂) and collecting solid deposits formed from said second diesel exhaust fluid; and
comparing the amount and/or type of deposits as between said DEF₁ and DEF₂.

A method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid doser in communication with said continuous conduit to introduce diesel exhaust fluid in the form of droplets and a deposit zone in said continuous conduit including a removable target to collect solid deposits formed from the diesel exhaust fluid;
introducing into said diesel exhaust fluid test system said diesel exhaust fluid droplets and collecting solid deposits formed from said diesel exhaust fluid while conducting at least one of the following:
   (i) determining a size of diesel exhaust fluid droplets introduced in a selected diesel engine being evaluated for deposit formation wherein the diesel exhaust fluid droplets in said test system is within +/- 10.0% or less of the droplet size introduced into said selected diesel engine being evaluated for deposit formation; or
   (ii) determining a flow rate of an airflow introduced into a selected diesel engine being evaluated for deposit formation wherein the airflow in said test system is within +/- 10.0% of the airflow introduced into said selected diesel engine being evaluated for deposit formation; or
   (iii) determining an exhaust temperature in a selected diesel engine being evaluated for deposit formation wherein the increase in temperature of said airflow in said diesel exhaust test system is within +/- 10.0% or less of the exhaust temperature of said selected diesel engine being evaluated for deposit formation; or
   (iv) determining a first residence time from the introduction of said diesel exhaust fluid in the form of droplets in said test system until said droplets reach said removable target and determining a second residence time that occurs from the injection of diesel exhaust fluid droplets in a diesel engine being evaluated to the time that such droplets impinge upon said diesel engine exhaust system surface, and setting the first residence time to be within +\- 10.0% or less of said second residence time.

A method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid (DEF) doser in communication with said continuous conduit to introduce diesel exhaust fluid in the form of droplets and a deposit zone in said continuous conduit including a removable target to collect solid deposits formed from the diesel exhaust fluid;
introducing into said diesel exhaust fluid test system said diesel exhaust fluid droplets and collecting solid deposits formed from said diesel exhaust fluid while conducting at least one or both of the following:
   (i) determining a flow rate of an airflow introduced into a selected diesel engine under evaluation for deposit formation wherein the airflow in said test system is 1.0 % to 50.0 % of said airflow introduced into said selected diesel engine being evaluated;
   (ii) determining a total volume of DEF injected into a diesel engine under evaluation wherein the DEF injected in said test system is 1.0% to 50.0% of said DEF injected into said selected diesel engine being evaluated.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is an overview of a contemplated and preferred diesel emission fluid test system herein.

### DETAILED DESCRIPTION OF PREFERRED EMBODIMENTS

It should be noted that reference herein to diesel emission fluid (DEF) is reference to the use of a solution of urea and water. Such DEF fluid is understood as an important component of Selective Catalytic Reduction (SCR) systems, which are utilized to reduce nitrogen oxide (NOx) emissions from diesel engines. The SCR systems generally operate by injecting DEF into the exhaust stream, where heated exhaust converts DEF to ammonia where it then reacts with NOx over a catalyst, converting it to nitrogen and water. However, as alluded to above, DEF solutions can also lead to deposit formation that can interfere with optimization of exhaust systems and SCR operations.

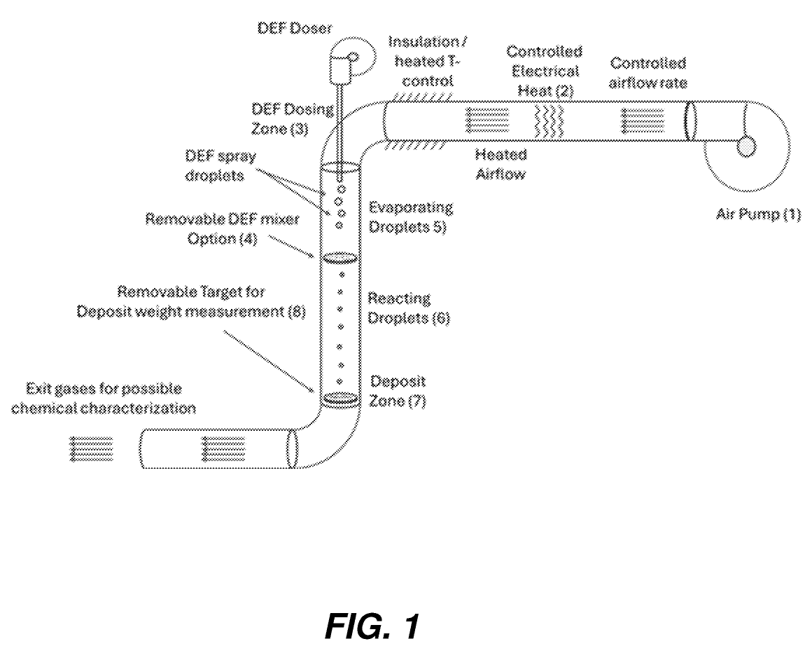

With the above in mind, attention is directed to FIG. 1, which as noted, represents an overview of a contemplated and preferred diesel exhaust fluid test system herein. As can be seen, the system has a continuous conduit type configuration, such as a continuous tubular construction although other geometries are contemplated. The cross-sectional dimensions of the preferred tubular type configuration illustrated in FIG. 1 preferably falls in the range of 1.0 inches to 6.0 inches, including all values and increments therein. Accordingly, the diameter of the tube in FIG. 1 is contemplated to be 1.0 inch, 2.0 inch, 3.0 inch, 4.0 inch, 5.0 inch or 6.0 inch. One particular preferred cross-sectional diameter for the tube shown in FIG. 1 falls in the range of 2.0 inches to 4.0 inches.

An air pump (1) is provided that preferably provides a controlled airflow in the range of 1.0 to 100 cubic feet per minute (CFM). The controlled airflow rate is then subject to controlled heating, preferably electrical heating as shown at (2) that raises the temperature of the air flow to trigger deposit formation, such as a preferred temperature range of 150° C. to 250° C. The airflow then preferably passes through an insulated and heated temperature control section to maintain the selected temperature range and is then routed to a DEF dosing zone (3).

As illustrated, a DEF doser is fluidly connected to a source of DEF (not shown) can introduce DEF droplets into the heated airflow. It is contemplated that the introduction of DEF droplets may be configured to be at an injection rate that is in line with the dosing rate that occurs in the actual diesel engine environment. In addition, the DEF droplets introduced into the heat airflow are preferably adjusted in size so that their volume is within +/- 10.0 % or less of the droplet volume that that occurs in the actual diesel engine environment being evaluated for deposit formation. More preferably, DEF droplet volume is within +/- 9.0 %, +/- 8.0 %, +/- 7.0%, +/- 6.0%, +/- 5.0 %, +/- 4.0 %, +/- 3.0%, +/- 2.0 % or +/- 1.0 % of the droplet volume that occurs in that actual diesel engine SCR environment being evaluated for deposit formation. The DEF doser may preferably comprise a controlled needle syringe pump. Optionally, one may utilize a DEF mixer (4) in the airflow stream that is contemplated to include a stainless-steel grit that operates to more uniformly distribute the DEF evaporation droplets (5) that are introduced by the DEF doser.

Furthermore, as alluded to above, the DEF doser is one that can be configured to introduce a first diesel exhaust fluid (DEF₁) followed by collecting the solid deposits formed from such first diesel exhaust fluid. This can then be followed by introduction of a second diesel exhaust fluid (DEF₂) and collecting deposits formed from such second diesel exhaust fluid. Then, one can compare the amount and type (e.g., chemical composition) of the deposits as between DEF₁ and DEF₂. The chemical composition of the deposits may therefore include, depending upon a given DEF feed, solid urea, isocyanic acid, biuret, triuret, cyanuric acid, ammelide, ammerline, or melamine. In addition, DEF₁ may be configured to be without additives to reduce deposit formation and DEF₂ may be configured to include additives to reduce deposit formation

In addition, the flow rate of the heated airflow containing the DEF droplets is also preferably controlled to reflect the flow rate of the DEF introduced into the actual diesel engine environment being evaluated for deposit formation. Similar to the above, the heated airflow containing the DEF droplets is preferably set to be within +/- 10.0 %, +/- 9.0 %, +/- 8.0 %, +/- 7.0%, +/- 6.0%, +/- 5.0 %, +/- 4.0 %, +/- 3.0%, +/- 2.0 % or +/- 1.0 % of the flow rate of the DEF introduced into the actual diesel engine SCR environment

The DEF droplets so produced may then be identified as reacting droplets (6) that are then introduced into a deposit zone (7) where the temperature of the DEF is still contemplated to be in the range of 150° C. to 250° C. and any deposits that are then formed can be collected in deposit zone (7) that includes a removable target (8). The removable target (8) is preferably made of 409 stainless steel or SCR catalyst substrate material, such as corderite ceramic or titanium dioxide.

Preferably, the temperature of the reacting DEF droplets (6) are also set to reflect the exhaust temperature of the actual diesel engine being evaluated for deposit formation. Similar to the above, the temperature of the reacting droplets are preferable set to a temperature that is within +/- 10.0 %, +/- 9.0 %, +/- 8.0 %, +/- 7.0%, +/- 6.0%, +/- 5.0 %, +/- 4.0 %, +/- 3.0%, +/- 2.0 % or +/- 1.0 % of the exhaust temperature of the actual diesel engine SCR system being evaluated for deposit formation.

Preferably, the time from injection of droplets out of the DEF Doser to the time that the droplets reach the removable target 8, which may be identified as droplet residence time, is again set to reflect a corresponding droplet residence time that occurs in the actual diesel engine being evaluated for droplet formation (i.e. the time from injection of the droplets to the time that the droplets may impinge upon the exhaust system surface). The droplet residence time out of the DEF Doser until it reaches the removable target 8 is therefore preferably within +/- 10.0 %, +/- 9.0 %, +/- 8.0 %, +/- 7.0%, +/- 6.0%, +/- 5.0 %, +/- 4.0 %, +/- 3.0%, +/- 2.0 % or +/- 1.0 % of the time from injection of the droplets in the diesel engine SCR system being evaluated to the time that the droplets may impinge upon such diesel engine exhaust system surface.

It should be noted that optionally, one may include additional intermediatory sample ports between the evaporating droplet zone (5) and deposit zone (7) to further evaluate the formation of any other potentially undesirable side-products.

Removable target (8) preferably comprises a filter where solid deposits formed from the diesel emission fluid are collected and gases are allowed to pass. Such deposits may include relatively high molecular weight materials (e.g., biuret, triuret, cyanuric acid, ammelide, ammeline, or melamine) can be collected. As may be appreciated the removable target (8) can be removed and the deposits can be evaluated in terms of amount and type for a given testing conditions (e.g., airflow rate and temperature). In addition, as illustrated, exit gases may be collected and directed to other testing systems (e.g., gas-chromatograph mass spectral analysis systems) to identify and chemically characterize the exhaust gas flow output.

As also noted above, the present invention provides a method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid doser in communication with said continuous conduit to introduce diesel exhaust fluid in the form of droplets; and a deposit zone in said continuous conduit including a removable target to collect solid deposits formed from the diesel emission fluid;
introducing into said diesel exhaust fluid test system a diesel exhaust fluid and collecting solid deposits formed from said diesel exhaust fluid while conducting at least one or more of the following:
   (i) determining a size of diesel exhaust fluid droplets introduced in a selected diesel engine being evaluated for deposit formation wherein the diesel exhaust fluid droplets in said test system are within +/- 10.0% or less of the diesel exhaust fluid droplet size introduced into said selected diesel engine being evaluated for deposit formation; or
   (ii) determining a flow rate of an airflow introduced into a selected diesel engine being evaluated for deposit formation wherein the airflow in said test system is within +/- 10.0% or less of the airflow introduced into said selected diesel engine being evaluated for deposit formation; or
   (iii) determining an exhaust temperature in a selected diesel engine being evaluated for deposit formation wherein the increase in temperature of said airflow in said diesel exhaust test system is within +/- 10.0% or less of the exhaust temperature of said selected diesel engine being evaluated for deposit formation; or
   (iv) determining a first residence time from the introduction of said diesel exhaust fluid in the form of droplets in said test system until said droplets reach said removable target and determining a second residence time that occurs from the injection of diesel exhaust fluid droplets in a diesel engine being evaluated to the time that such droplets impinge upon said diesel engine exhaust system surface, and setting the first residence time to be within +\- 10.0% or less of said second residence time.

Furthermore, it should now be appreciated that the diesel exhaust fluid test system described herein may be configured as a downsized representation of a selected diesel engine under evaluation. To preferably achieve this goal the method for testing diesel exhaust fluid for deposits proceeds with initially providing the diesel exhaust fluid test system comprising an air pump connected to a continuous conduit to provide an airflow, a heating zone in said continuous conduit to increase the temperature of said airflow, a diesel exhaust fluid (DEF) doser in communication with said continuous conduit to introduce diesel exhaust fluid in the form of droplets and a deposit zone in said continuous conduit including a removable target to collect solid deposits formed from the diesel exhaust fluid. One then introduces into said diesel exhaust fluid test system a diesel exhaust fluid and collects solid deposits formed from said diesel exhaust fluid while conducting at least one or both of the following: (i) determining a flow rate of an airflow introduced into a selected diesel engine under evaluation for deposit formation wherein the airflow in said test system is 1.0 % to 50.0 % of said airflow introduced into said selected diesel engine being evaluated; (ii) determining a total volume of DEF injected into a diesel engine under evaluation wherein the DEF injected in said test system is 1.0 % to 50.0% of said DEF injected into said selected diesel engine being evaluated. Even more preferably, when the airflow in said test system is set to a selected percentage value that is 1.0 % to 50.0% of the airflow introduced into the selected diesel engine being evaluated, the total volume of DEF injected into the test system is also preferably set to the same percentage reduction, or within +\- 10.% or less of such reduction. For example, if the airflow in said test system is set to 25.0 % of the airflow introduced into the selected diesel engine being evaluated, the total volume of DEF injected into the test system is set to 25.0 % +/- 2.5 % of the total volume of the DEF injected into the diesel engine under evaluation.

It should therefore be appreciated that the DEF test system identified herein provides a relatively small-scale test system to evaluate deposit formation of DEF solutions. Among other things, the DEF test system herein is particularly contemplated to allow one to discriminate the differences as between DEF deposit formation with respect to pure DEF (i.e. without additives to reduce deposit formation) versus DEF solutions that contain selective additives to reduce deposit formation. Moreover, the DEF test system herein is contemplated to allow for testing and comparison of different DEF fluids relative to one another regarding their tendency to form deposits in a given SCR system

1. A diesel exhaust fluid test system comprising:
a. an air pump connected to a continuous conduit to provide an airflow;
b. a heating zone in said continuous conduit to increase the temperature of said airflow;
c. a diesel exhaust fluid doser in communication with said continuous conduit to introduce diesel exhuast fluid in the form of droplets;
d. a deposit zone in said continuous conduit including a removable target to collect solid deposits formed from the diesel exhaust fluid.

2. The diesel exhuast fluid test system of claim 1 wherein said continuous conduit has a diameter in the range of 1.0 inches to 6.0 inches.

3. The diesel exhuast fluid test system of claim 1 wherein said air pump provide an airflow in the range of 1.0 cubic feet per minute to 100 cubic feet per minute.

4. The diesel exhuast test system of claim 1 wherein said heating zone increase the temperature of said airflow to a temperature of 150 ° C. to 250 ° C.

5. The diesel exhaust test system of claim 1 wherein said deposit zone is at a temperature of 150 ° C. to 250 ° C.

6. A method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid doser in communication with said continuous conduit to introduce diesel exhaust fluid in the form of droplets and a deposit zone in said continuous conduit including a removable target to collect solid deposits formed from the diesel exhaust fluid;
introducing into said diesel exhuast fluid test system a first diesel exhaust fluid (DEF₁) and collecting solid deposits formed from said first diesel exhaust fluid;
introducing into said diesel exhaust fluid test system a second diesel exhaust fluid (DEF₂) and collecting solid deposits formed from said second diesel exhaust fluid; and
comparing the amount and/or type of deposits as between said DEF₁ and DEF₂.

7. The method of claim 6 wherein said DEF₁ is without additives to reduce deposit formation and DEF₂ includes additives to reduce deposit formation.

8. The method of claim 6 wherein said continuous conduit has a diameter in the range of 1.0 inches to 6.0 inches.

9. The method of claim 6 wherein said air pump provides an airflow in the range of 1.0 cubic feet per minute to 100 cubic feet per minute.

10. The method of claim 6 wherein said heating zone increase the temperature of said airflow to a temperature of 150 ° C. to 250 ° C.

11. The method of claim 6 wherein said deposit zone is at a temperature of 150 ° C. to 250 ° C.

12. A method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid doser in communication with said continuous conduit to introduce diesel exhaust fluid in the form of droplets and a deposit zone in said continuous conduit including a removable target to collect solid deposits formed from the diesel exhaust fluid;
introducing into said diesel exhaust fluid test system said diesel exhaust fluid droplets and collecting solid deposits formed from said diesel exhaust fluid while conducting at least one of the following:
(ii) determining a flow rate of an airflow introduced into a selected diesel engine being evaluated for deposit formation wherein the airflow in said test system is within +/- 10.0% of the airflow introduced into said selected diesel engine being evaluated for deposit formation; or
(iii) determining an exhaust temperature in a selected diesel engine being evaluated for deposit formation wherein the increase in temperature of said airflow in said diesel exhaust test system is within +/- 10.0% or less of the exhaust temperature of said selected diesel engine being evaluated for deposit formation; or
(iv) determining a first residence time from the introduction of said diesel exhaust fluid in the form of droplets in said test system until said droplets reach said removable target and determining a second residence time that occurs from the injection of diesel exhaust fluid droplets in a diesel engine being evaluated to the time that such droplets impinge upon said diesel engine exhaust system surface, and setting the first residence time to be within +\- 10.0% or less of said second residence time.

13. The method of claim 12 wherein said continuous conduit has a diameter in the range of 1.0 inches to 6.0 inches.

14. The method of claim 12 wherein said air pump provides an airflow in the range of 1.0 cubic feet per minute to 100 cubic feet per minute.

15. The method of claim 12 wherein said heating zone increases the temperature of said airflow to a temperature of 150 ° C. to 250 ° C.

16. The method of claim 12 wherein said deposit zone is at a temperature of 150 ° C. to 250 ° C.

17. The method of claim 12 wherein the method includes items (i), (ii), (iii) and (iv).

18. A method for testing diesel exhaust fluid for deposits comprising:
providing a diesel exhaust fluid test system comprising an air pump connected to a continuous conduit to provide an airflow, a heating zone in said continuous conduit to increase the temperature of said airflow, a diesel exhaust fluid (DEF) doser in communication with said continuous conduit to introduce diesel exhaust fluid in the form of droplets and a deposit zone in said continuous conduit including a removable target to collect solid deposits formed from the diesel exhaust fluid;
introducing into said diesel exhaust fluid test system said diesel exhaust fluid droplets and collecting solid deposits formed from said diesel exhaust fluid while conducting at least one or both of the following:
(i) determining a flow rate of an airflow introduced into a selected diesel engine under evaluation for deposit formation wherein the airflow in said test system is 1.0 % to 50.0 % of said airflow introduced into said selected diesel engine being evaluated;
(ii) determining a total volume of DEF injected into a diesel engine under evaluation wherein the DEF injected in said test system is 1.0% to 50.0% of said DEF injected into said selected diesel engine being evaluated.

19. The method of claim 18 comprising introducing into said diesel exhaust fluid test system a diesel exhaust fluid and collecting solid deposits formed from said diesel exhaust fluid while conducting both of the following:
(i) determining a flow rate of an airflow introduced into a selected diesel engine under evaluation for deposit formation wherein the airflow in said test system is 1.0 % to 50.0 % of said airflow introduced into said selected diesel engine being evaluated; and
(ii) determining a total volume of DEF injected into a diesel engine under evaluation wherein the DEF injected in said test system is 1.0% to 50.0% of said DEF injected into said selected diesel engine being evaluated.

20. The method of claim 19 wherein said percentage selected in step (i) is within 10.0% or less of the percentage selected in step (ii).
